(19) United States
(12) Patent Application Publication
(10) Pub. No.: US 2007/0223540 A1
(43) Pub. Date: Sep. 27, 2007

(54) PULSED LASER

(75) Inventors: Thomas Sudmeyer, Zurich (CH); Sergio Vincenzo Marchese, Zurich (CH); Ursula Keller, Uitikon (CH)

Correspondence Address: RANKIN, HILL, PORTER & CLARK LLP, 38210 Glenn Avenue, WILLOUGHBY, OH, 44094-7808, US

(73) Assignee: TIME-BANDWIDTH PRODUCTS AG, Zurich (CH)

(21) Appl. No.: 11/627,673

(22) Filed: Jan. 26, 2007

Related U.S. Application Data
(60) Provisional application No. 60/762,671, filed on Jan. 27, 2006.

(51) Int. Cl. H01S 3/098

(52) U.S. Cl. 372/18

(57) ABSTRACT

The invention concerning a pulsed laser is provided and includes an optical resonator being defined by at least two reflective elements, and the optical resonator defining a laser radiation beam path; the laser further including a solid-state gain structure arranged so as to be in the beam path, the gain structure being operable to emit laser radiation by stimulated emission upon being pumped; a housing operable of maintaining a vacuum or gas composition different from ambient gas within the housing, the housing defining an inside, which encloses at least a part of the optical resonator, so that at least a part of the beam path proceeds within the housing; and a mode locker arranged so as to be in the beam path; wherein the gas composition and/or gas pressure in the housing is controlled, and a gas mixture inside the housing has an optical nonlinearity which is lower than the nonlinearity of air.

### BRIEF SUMMARY OF THE INVENTION

It is therefore an object of the invention to provide a pulsed laser for generating radiation pulses of high pulse energy.

A further object is to provide a passively mode-locked thin-disk laser resonator with high pulse energy.

Yet a further object is to scale the pulse energy of a passively mode-locked thin-disk laser resonator into a regime where it can be used for micro machining and other applications.

An even further object is to scale the pulse energy of a passively mode-locked thin-disk laser above 2 microjoules.

Yet another object is to scale the pulse energy directly obtained from a passively mode-locked thin-disk laser into a regime above 2 microjoules with pulse duration below 10 ps.

According to a first aspect, a laser is provided, the laser being operable to emit electromagnetic laser radiation and comprising an optical resonator being defined by at least two reflective elements, and the optical resonator defining a laser radiation beam path; the laser further comprising:
a solid-state gain structure arranged so as to be in the beam path, the gain structure being operable to emit laser radiation by stimulated emission upon being pumped;
a housing operable for maintaining a vacuum or gas composition different from ambient gas within the housing, the housing defining an inside, which encloses at least a part of the optical resonator, so that at least a part of the beam path proceeds within the housing; and
a mode locker arranged so as to be in the beam path;
wherein at least one of the following condition holds:
   the housing is gas-proof and a gas pressure inside the housing is below atmospheric gas pressure;
   the housing is gas-proof and a gas atmosphere inside the housing is different from an ambient gas atmosphere;
   the laser comprises a pump for evacuating gas from the housing, and/or the housing is connectable (for example by comprising a socket or other interface) to a pump;
   the laser comprises a gas supply for supplying gas of a composition different from an ambient atmosphere to the inside of the housing, or the housing being connectable to such a gas supply (for example by comprising a socket or other interface).

In other words, the last one of the above features means that the gas composition and/or gas pressure in the housing is controlled. To this end, the housing may be gas-proof. It may also be partially gas-proof (leaky). Moreover, there may also be a continuous or discontinuous flow of the gas from the housing to the outside or vice-versa.

The invention also concerns a laser for generating pulsed laser radiation, the laser comprising an optical resonator being defined by at least two reflective elements, and the optical resonator defining a laser radiation beam path; the laser further comprising:
a solid-state gain structure including an essentially flat gain medium having two end faces, where a first of the end faces is in physical contact with a cooler, and where the beam path hits the other one of the end faces, and where as a whole is reflecting for the laser radiation, the structure including the gain structure and possibly including further layers in contact with the first end face;
an optical pump operable to impinge the gain structure by pump radiation;
a passive mode locker arranged so as to be in the beam path;
a housing operable for maintaining a vacuum or gas composition different from ambient gas within the housing, the housing defining an inside, which encloses at least a part of the optical resonator, so that at least a part of the beam path proceeds within the housing; and
a means for maintaining a gas atmosphere in the inside of the housing, an air content of which gas atmosphere is lower than an air content of ambient atmosphere;
wherein operating parameters of the optical pump, an efficiency of the solid-state gain structure and a beam path length in the resonator are adapted to each other for the laser to yield radiation pulses of at least 2 μJ radiation energy.

The laser radiation—and, at least for a solid-state gain material, preferably also the pump radiation—is reflected, for example, by a layer structure below (seen from the side of incidence) the gain structure. Such a layer structure may for example be a Bragg mirror below the quantum wells for VECSELs or a dielectric mirror below the gain crystal for standard thin disk lasers.

The beam path length l—here defined to be the optical path a pulse travels in the resonator during a roundtrip, corresponding to 2L (back and forth), when L is an optical resonator length between two end reflecting elements—in the resonator is related to the repetition frequency f by way of the equation f=c/l The laser power P is related to the pulse energy Eₚ by way of the equation P=f Eₚ. The laser power is determined by the pump power Pₚ times an efficiency (sometimes called “optical-to-optical efficiency”) which is a property of the gain element, degree of output coupling and optical losses in the resonator and may depend on factors such as an intensity inside the resonator etc.

The invention further concerns a method for generating pulsed electromagnetic laser radiation, the method, comprising the steps of:
exciting an essentially plane thin-disk solid state gain structure, which has a surface extending essentially in a surface plane, to emit laser radiation from said surface, by impinging pump radiation on said solid state gain structure;
recirculating said laser radiation in a beam path in an optical resonator;
mode locking said laser radiation; and
maintaining a gas atmosphere in at least a part of the volume traversed by the beam path inside the optical resonator, which gas atmosphere has an air content of which gas atmosphere is lower than an air content of ambient atmosphere.

According to a second aspect of the invention, a laser for generating pulsed laser radiation is provided, the laser comprising an optical resonator being defined by at least two reflective elements, and the optical resonator defining a laser radiation beam path, the laser beam path at least partially traversing a gas atmosphere; the laser further comprising:
a solid-state gain structure arranged so as to be in the beam path, the gain structure being operable to emit laser radiation by stimulated emission upon being pumped;
an optical pump for pumping the gain structure;
a nonlinearity compensator at least partially compensating the calculated and/or measured nonlinearity of the gas atmosphere,
wherein operating parameters of the optical pump, an efficiency of the solid-state gain structure and a beam path length in the resonator are adapted to each other for the laser to yield radiation pulses of at least 2 μJ radiation energy.

The nonlinearity compensator may comprise a dispersive mirror or another element providing negative dispersion.

The gas atmosphere may be the air atmosphere of surrounding air. As an alternative, the laser with the nonlinearity compensator may further comprise a gas-proof or partially gas-proof external housing enclosing at least a part of the resonator, so that at least a part of the beam path proceeds within the housing, wherein the housing is evacuated or the gas pressure inside the housing is lower than the atmosphere gas pressure and/or wherein the housing contains a gas or a gas mixture having a nonlinearity lower than the non-linearity of air and/or wherein there may be a gas transfer between the housing and the outside.

The nonlinearity compensator preferably is an element providing negative dispersion. Preferably, it includes at least one GTI mirror (i.e. mirror coated with at least one coating that result(s) in a negative group delay dispersion (typically of >50 fs²; the coatings typically may form a Gires-Tournois-Etalon), and the beam path in the resonator as a whole is such that in each roundtrip in the resonator the beam undergoes a plurality of hits on a GTI mirror. If the nonlinearity in the resonator is sufficiently reduced by invention according to its first aspect (e.g. evacuating air or replacing it with another gas), few bounces on GTI mirrors are sufficient for nonlinearity compensation. For example, in a particular embodiment, 8 GTI mirrors with 550 fs² negative dispersion can be used, resulting in 16 hits. With mirrors of 1000 fs² negative dispersion, this result would become possible with 8 bounces. If, however, the nonlinearity of the resonator is higher, a larger number of hits has been found to be required. For an air-filled resonator, according to the second aspect of the invention at least 20 hits, preferably at least 30 hits, especially preferred at least 40 hits, or even at least 50 hits are provided.

More in general, a solution-like pulse has to obey the approximate equation:

$${τ}_{p} \approx 1.76 \cdot \frac{2 \vert D \vert}{\vert {γ}_{SPM} \vert {E}_{p}} \qquad ( 1 )$$

where τₚ is the pulsewidth (full width half maximum FWHM) D the dispersion and Eₚ the pulse energy. The SPM parameter γ_{SPM} is related to the length d of a medium through which the radiation propagates, the vacuum wave number k=2π/λ, the peak intensity Iₚₑₐₖ, the peak power Pₚₑₐₖ the 1/e² mode area w²π, the nonlinear index of refraction n₂ and the nonlinear phase shift in the peak maximum φₙₗ as follows:

$${φ}_{nl} = {kn}_{2} {I}_{peak} d = {kn}_{2} \frac{2 {P}_{peak}}{{w}^{2} π} d = {γ}_{SPM} {P}_{peak} \qquad ( 2 )$$

This yields:

$${γ}_{SPM} = {kn}_{2} \frac{2 d}{π {w}^{2}} = \frac{4 {n}_{2} d}{λ {w}^{2}} \qquad ( 3 )$$

In a resonator, the contribution of all elements in the beam path has to be taken account of. This includes the contribution of air. Since the mode radius changes during propagation, the contributions of every piece of the path in air has to be summed up, so that an integral has to be solved:

$${γ}_{SPM}^{rt , air} = \frac{4 {n}_{2}^{air}}{λ} {\int }_{0}^{{L}_{cav}} \frac{2 ⅆ z}{{w}^{2} ( z )} \qquad ( 4 )$$

The factor 2 is due to the fact that the cavity during each round trip (rt) is traversed twice: back and forth.

It has been found by the inventors, that the contribution to γ_{SPM} by a thin-disk gain element are negligible, but the contribution of air is substantial. Next to air, also a contribution of a Brewster plate potentially placed in the resonator has to be taken account of:

$${γ}_{SPM}^{rt} = {γ}_{SPM}^{rt , BP} + {γ}_{SPM}^{rt , air} \qquad ( 5 )$$

For air, the published nonlinear index of refraction (@800 nm) is approximately n₂=2.9*10⁻¹⁹ cm²/W. For a fused silica Brewster plate, one may assume n₂=2.5*10⁻¹⁶ cm²/W. From equations (5), (4), (3) (for the Brewster plate) and (1) one gets, for a given resonator design, a condition to be fulfilled for the dispersion D to achieve a pulse energy Eₚ and at pulsewidth of τₚ.

Especially preferred are resonators of a length exceeding 10 m. In these, the contribution of air to the SPM parameter is considerably higher than the contribution of a Brewster plate.

The overall (negative) dispersion acting on a laser pulse during one round trip in the resonator is preferably chosen to be—in the case the resonator in ambient air—at least −20,000 fs², especially preferred at least −40,000 fs².

In the following considerations hold for both aspects of the invention.

The laser may comprise pump means of the kind described in U.S. Pat. No. 6,834,064.

The pulse length is preferably engineered to be 20 ps or less, especially preferred 10 ps or less. The invention is especially suitable for generating femtosecond pulses, i.e. pulses having a width (FWHM) of 1 ps or less. A generally preferred range is between 100 fs and 10 ps.

The laser may be operated at any suitable wavelength, in the infrared range, for example near infrared or mid infrared range, or in the visible range. According to a special embodiment, the wavelength is between 1020 nm and 1064 nm.

The laser may, for example, be operated in a nearly single transverse mode operation with M²<3. M² denotes the well-known quantity M squared which is a measure of the relationship between the actual beam parameter product and the beam parameter product of an ideal Gaussian beam.

According to an embodiment of the invention, the gain structure is a solid-state gain where stimulated emission takes place in an optically pumped solid, such as a crystal or glass doped by optically active ions, often either of rare-earth or transition metal elements. Such solid-state gain elements in the narrower sense for example include Yb:YAG, Yb:KYW, Ti:Sapphire, Nd:YAG, an Erbium doped solid or any other laser of the type of a material doped by an optically active element. According to a special embodiment, the gain structure may be a solid-state gain structure in the broader sense of the word, especially a semiconductor gain structure. Also the semiconductor gain structure is preferably optically pumped but may potentially as an alternative be electrically pumped.

The gain structure in any case is such that the radiation traverses only a short path of less than 5 mm, preferably less than 1 mm in the gain material. This especially excludes set-ups where the gain element is an optical fiber.

The gain structure may be a thin-disk gain structure, which includes an essentially flat, disk-like gain medium having two end faces, where a first of the end faces is in physical contact with a mount, and where the other one of the end faces is hit by both, the laser radiation and the pump radiation. The gain structure with the possible layer system underneath as a whole then is reflecting for the laser radiation, and may also be reflecting for the pump radiation. Such a thin-disk gain element may comprise a thickness of only 400 μm, or less, preferably only 200 μm or less and may be mounted on a cooler where the first end face is in contact with the cooler and the other face is hit by both, pump radiation and by laser radiation circulating in the resonator. Moreover, there may be pump radiation re-directing means for example including a parabolic mirror which means may re-direct reflected pump radiation to again be incident on the gain element. This is due to the fact that the thickness of a thin-disk gain element is not only thinner, usually much thinner than a mode radius, but also thinner than a pump radiation absorption length. Thus, the efficiency of the laser may be significantly enhanced if unabsorbed pump radiation is again incident on the gain structure.

As an alternative, the gain structure may be different from a thin disk gain structure and have a different shape. Also such alternative shapes may be cooled by being in physical contact with a cooler.

In case the gain structure is a semiconductor gain structure, the gain structure is preferably of the VECSEL type, i.e. the radiation is emitted perpendicularly or at an angle to a layer sequence of the gain structure.

The optical pump source may be a diode laser or include a plurality of diode lasers. The pump source is usually of a cw type but may also be pulsed. If it is pulsed, the pulse repetition frequency may be adapted to the pulse repetition rate of the laser. The pump means may be of the kind described in U.S. Pat. No. 6,834,064, which is incorporated herein by reference.

The laser may comprise a cooler for cooling the gain medium. A cooler for cooling the gain medium may be an active cooler which includes a cooling medium transporting heat away from the contact surface between the cooler and the gain structure or other active means (such as a Peltier cooling) for transporting heat away. As an alternative, the cooler may be a passive cooler comprising at least one of a large heat reservoir and of a large cooling surface including cooling ribs or the like.

The laser may further comprise a mode locker. The mode locker may be a passive mode-locker and may include a saturable absorber. As an alternative, the laser may comprise other mode-lockers (such as Kerr Lens Mode Lockers, active mode lockers etc.). The mode locker may include a saturable absorber for example in a semiconductor arrangement also acting as a resonator mirror. Such a saturable absorber mirror may optionally also be in contact with the cooler of the gain structure or with a different cooler.

If the mode locker includes a mirror including a saturable absorber of semiconductor material, it preferably has a high saturation fluence of for example at least 50 μJ/cm², preferably at least 150 μJ/cm². By this, one achieves that the size of the beam on the mirror with the saturable absorber does not have to be too large.

The laser resonator is preferably such that a total length of the beam path in the resonator is at least 2 m, especially preferred 10 m or longer. For example, the beam path length in the resonator is between 20 m and 300 m (corresponding to a resonator length of between 10 m and 150 m if the resonator has two end mirrors, between which the radiation goes back and forth). By the long beam path, the repetition rate is reduced, and the energy per pulse is—for a given laser power—increased. The laser resonator may especially comprise at least one 4 f-imaging unit for enhancing the cavity length without changing mode sizes on the intra-resonator components present in design the resonator would have without the 4 f-imaging unit. More in general, a 4 f unit is defined by having a (negative) unity ray transfer matrix in the ABCD matrix analysis and thus as not changing the properties of the mode on the other resonator elements. As an alternative or in addition, the resonator may comprise a multi-pass-cell in which the beam path passes back and forth between two or more reflecting elements a plurality of times. At least one of the reflecting elements may be a GTI mirror, especially in embodiments of the invention according to its second aspect.

Examples of gases having a nonlinearity lower than the non-linearity of air are noble gases, for example He or Ne or Ar. The nonlinearities of refractive indices of air and other gases is for example addressed in the publication E. Nibbering et al, J. Opt. Soc. Am. B, Vol. 14, No 3, p. 650-660 (1997).

The laser may further comprise an outcoupling mirror with an outcoupling rate higher than the outcoupling rate of standard outcoupling mirrors. More concretely, the laser may—optionally—comprise an outcoupling mirror with an outcoupling rate of 5% or higher or of even 8% or higher, for example around 10%. By this, the pulse energy circulating in the cavity for a given output pulse energy is lower, which effect also reduces the nonlinearity.

The invention is based on the new insight: Scaling of the pulse energy in passively mode-locked thin disk lasers may be limited by the nonlinearity of air. This especially concerns lasers where a beam in the laser resonator traverses little solid-state material, for example only a small amount glass or other intracavity optical material. In thin-disk lasers, where the beam path in the gain element is short, this is especially the case. The few hundred micrometers beam path in the gain element are to be compared to several meters (for example 15 meters) of beam path in the air. The invention solves this problem by at least partially eliminating air in the resonator and/or by accounting for the nonlinearity by other means.

The invention, thus, has brought about the insight that lasers with pulse energies of 2 μJ or more, preferably 3 μJ or more, especially preferred at least 4 μJ, can be stable if the nonlinearly of air is dealt with.

Moreover, the inventors have shown for the first time that the nonlinearity of the atmosphere inside a passively mode-locked laser may be more important for the pulse formation and stability than the nonlinearity of the other optical components.

The invention further also concerns a method for micro-machining, waveguide writing, ablation, wavelength conversion, or for obtaining short pulses in a compression system, the method comprising the steps of generating pulsed electromagnetic radiation by a laser or a method according to the first and/or second aspect, and further comprising the step of directing the laser radiation onto a desired object.

### BRIEF DESCRIPTION OF THE DRAWINGS

In the following, embodiments of the invention are described referring to drawings. All drawings are schematical and not to scale. In the drawings, same reference numbers refer to corresponding elements.

FIGS. 1-6 show a illustrations of a different embodiment of a laser according to the invention.

### DETAILED DESCRIPTION OF THE INVENTION

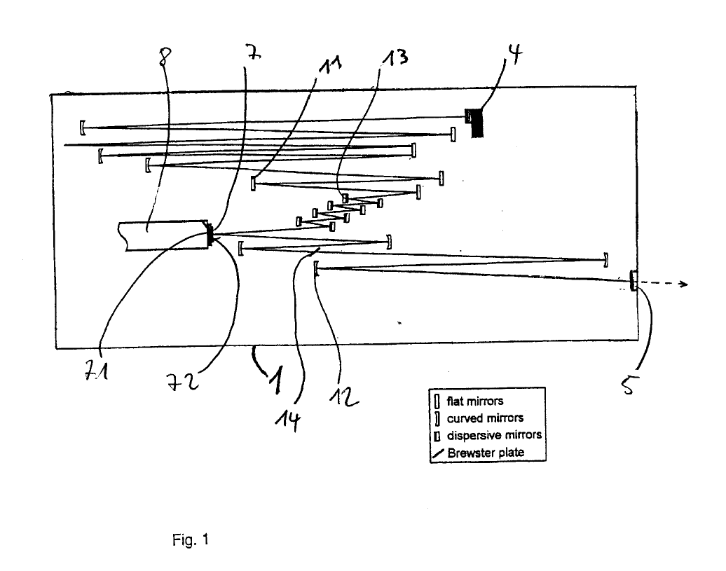

FIG. 1 shows an example of an apparatus, namely a laser according to the invention. In the laser shown, the housing 1 encases a laser resonator defined between two end mirrors. In the shown embodiment, a first end mirror 4 is a mirror which includes saturably absorbing semiconductor material for mode-locking. Such saturable absorber mirrors have been described in a number of publications including, for example, WO 96/36906, U.S. Pat. No. 6,826,219, and U.S. Pat. No. 6,538,298, and they are not described in any detail here. A second end mirror 5 is an outcoupling mirror reflecting a first portion of the laser radiation incident on it and transmitting a second portion thereof. The transparency of the outcoupling mirror 5 in all embodiments is preferably at least 5%, especially preferred at least 8%. The laser further comprises a thin-disk gain structure including a thin-disk gain element 7 mounted on a cooler 8. A first end face of the thin-disk gain element is in physical contact with the cooler or a system of at least one layer being in physical contact with the cooler. The second end face 7.2 is hit by the laser radiation circulating in the resonator. The laser further comprises an optical pump (not shown), for example including a plurality of laser diodes producing pump radiation which is also incident onto the second end face 7.2 of the gain element, from a normal direction or from an acute angle.

The system of at least one layer adjacent the first end face of the thin-disk gain element may include a reflecting coating or foil to enhance the reflectivity of the gain structure (including the reflecting coating or foil) for the laser radiation as a whole.

The laser resonator further comprises a plurality of mirrors re-directing the radiation within the resonator in order to make a large resonator length on a comparably small area possible and for having the possibility of influencing (collimating, focussing) the radiation beam without having to direct the radiation beam through material (such as a lens), which material may be dispersive and/or exhibit some nonlinearity. These re-directing mirrors (also called “folding mirrors” for some angles of incidence) may include flat mirrors 11 and curved mirrors 12. The curved mirrors have—as is known in the art—the purpose of focussing or collimating the radiation circulating in the resonator and thereby preventing a radiation beam from diverging.

The resonator further includes a Brewster plate 14, i.e. a transparent plate or a stack of plates placed at Brewster's angle in the radiation beam acting as a polarizer for the radiation circulating in the resonator.

Some of the mirrors of the resonator are dispersive mirrors 13. Such dispersive mirrors are preferably mirrors with a GTI coating, i.e. mirrors having a first reflecting face of low reflectivity and high transmittivity and a second reflecting face of high reflectivity, where the first and second reflecting faces have a well-defined spacing between them adapted to the frequency of the radiation circulating in the resonator. Mirrors with GTI coating—GTI mirrors—are available on the market and are known for producing chromatic dispersion. The GTI mirrors are chosen such that the group delay dispersion (GDD) for the radiation circulating in the resonator is negative. In the shown embodiment, eight GTI mirrors are shown so that a light pulse during a roundtrip in the resonator undergoes sixteen hits on a GTI mirror. This compensates both, positive dispersion and nonlinearity of the elements in the resonator.

The shown number of dispersive mirrors may vary. Especially, if the gas remaining inside the housing has a very small nonlinearity, the number of dispersive mirrors may be reduced. The number of dispersive mirrors may also be enhanced, for example if the intracavity pulse energy is higher than 10 μJ or even 50 μJ or higher or 100 μJ or higher.

In the laser of FIG. 1 the nonlinearity of the gas inside the housing is reduced by exchanging the air with helium (which has substantially lower nonlinearity than air), or another gas with a lower nonlinearity than air, or by evacuating the housing. To this end, the housing may be gas-proof, and the inside may be at a lower gas pressure than ambient atmosphere (under standard conditions; standard temperature and pressure STP).

It may as an alternative be partially gas-proof (leaky), and there may be a continuous or discontinuous flow of the gas from the housing to the outside or vice-versa. To this end, the casing may comprise an inlet and/or an outlet connected to a gas source (such as a helium source) and/or a vacuum pump, respectively.

In the shown embodiment, the outcoupling mirror 5 is illustrated as a partially transparent window of the housing (in which the outcoupling mirror need not be fixedly fastened to the housing but may also be roughly fitted in an opening thereof). In practice, this need not be the case.

The housing may as a first alternative encompass the whole resonator including the outcoupling mirror and itself be transparent for the laser radiation or comprise a transparent window for the output radiation.

As yet an other alternative, the housing may encompass a part of the resonator only. For example, at most 20%, preferably at most 10% of the light path is in air. In such an embodiment, for example, the laser head (including the gain structure and the cooler) need not be within the housing, and for example only passive components not requiring electricity or cooling are within the housing. As a first option, the housing may comprise a window for the radiation circulating in the laser. Such a window may for example be a Brewster window and potentially replace the Brewser plate 14. The window may, alternatively, be used at a different angle and may be coated with layers resulting in low reflectivity of, for example, less than 5% or even less than 2% for the laser radiation. As a second option—if the housing is “leaky” and constantly flooded by helium or an other low-nonlinearity-gas—the housing may comprise an opening through which the laser radiation may circulate.

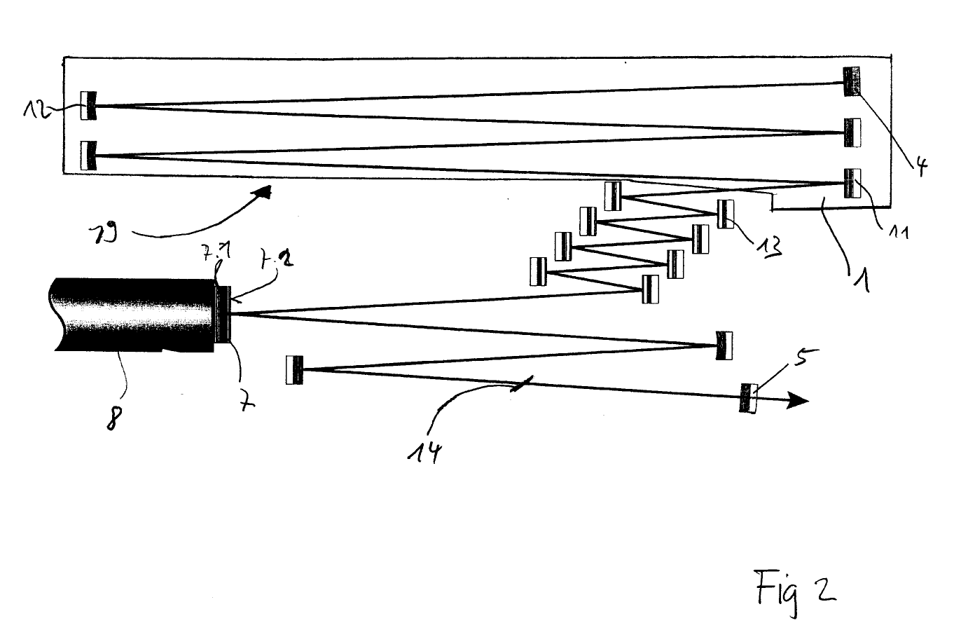

Such a variant is shown in FIG. 2, where only the differences to the embodiment of FIG. 1 are described in detail. According to this variant, the mirrors shown as topmost five of the mirrors 4, 11, 12 in the drawing form a 4 f extension 19, i.e. add to the beam path in the resonator without changing the beam shape in other parts of the resonator. In practice, the 4 f extension may make up a large part of the entire beam path in the resonator. In the shown variant, only the radiation in the 4 f extension proceeds inside the housing 1.

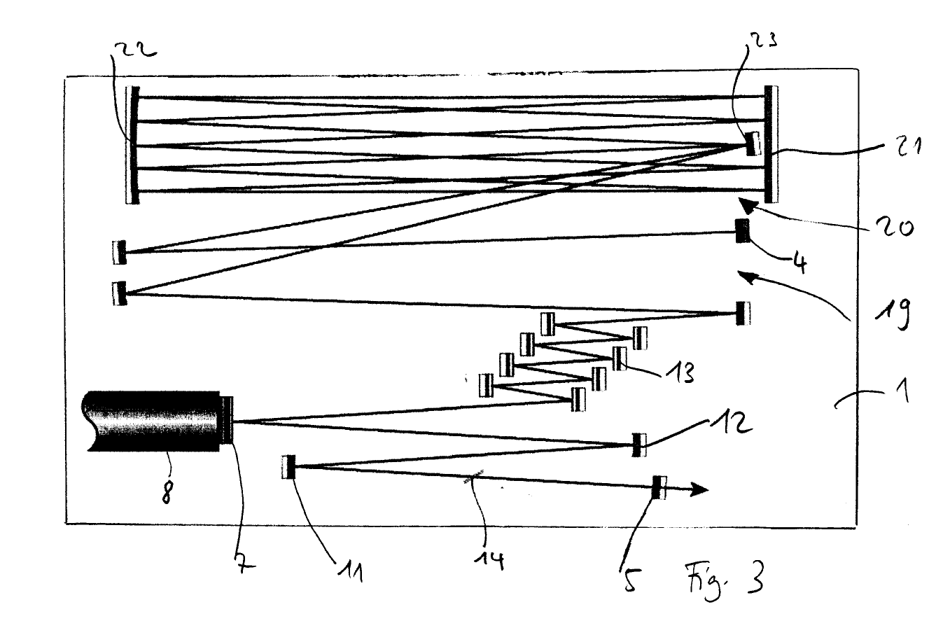

The embodiment of FIG. 3 is of the above-described kind where the entire resonator is inside the housing. As a further difference to the embodiment of FIG. 2, in addition to the 4 f extension of the resonator, the laser also comprises a multi-pass cell 20. Multi-pass cells are known in the art. They comprise at least two reflecting elements between which a beam directed into the multi-pass cell goes back and forth a plurality of times before it again leaves the multi-pass cell. The coupling into and out from the multi-pass cell may be done by an appropriate opening in one of the reflecting elements, or by a small mirror placed inside the multi-pass cell. In the shown embodiment, the multi-pass cell comprises a flat mirror 21 and a curved mirror 22 as well as an in- and outcoupling mirror 23. The multi-pass cell allows to again enhance the resonator length when the resonator is set up on a limited area (or in a limited volume, respectively.

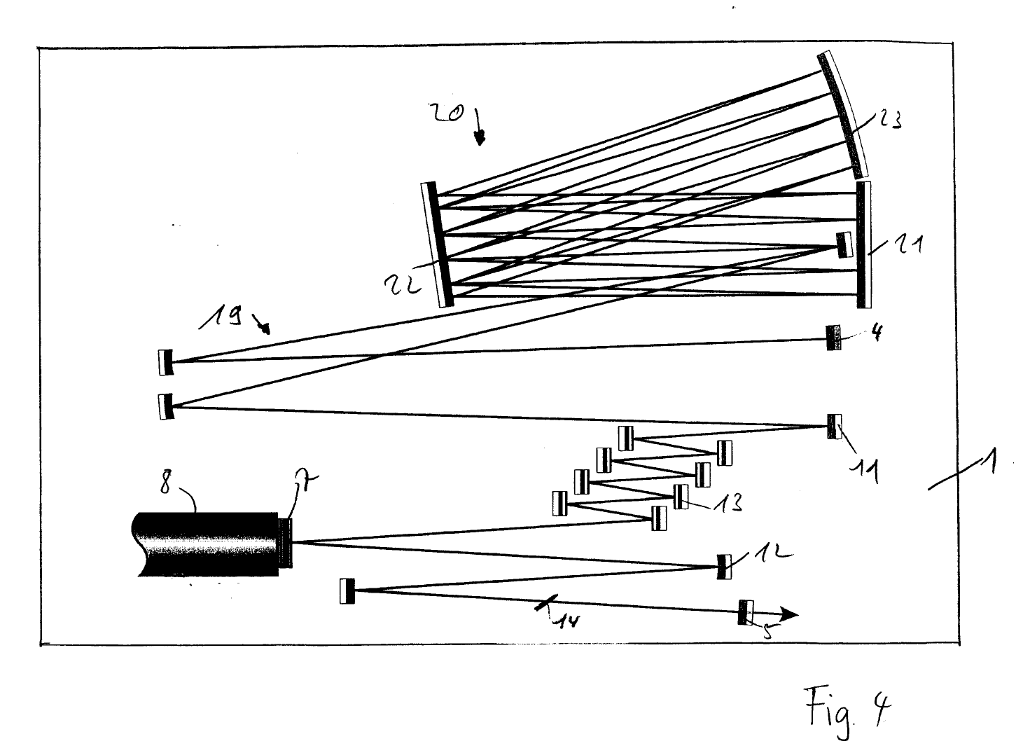

Yet a further embodiment making an even longer resonator possible is shown in FIG. 4, where the multi-pass cell 20 is “folded”, i.e. comprises three mirrors 21, 22, 23.

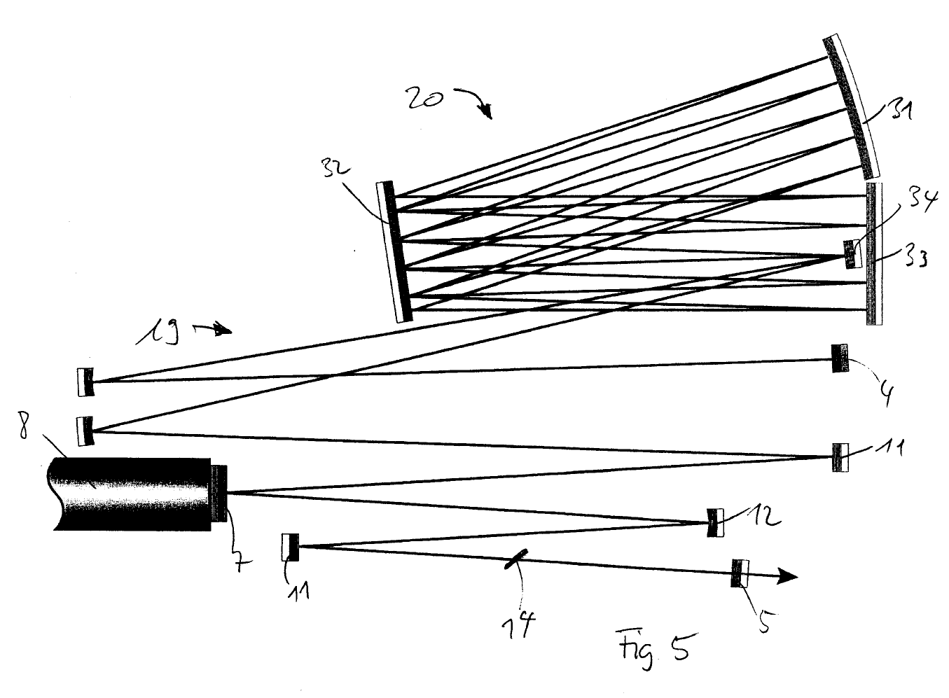

The embodiment of FIG. 5 is an example of an embodiment according to the second aspect of the invention. It does not necessarily need a housing that can be flooded with a low-nonlinearity-gas or can be evacuated. Instead, it comprises a nonlinearity compensator adding a high negative dispersion of at least −20,000 fs² or more per round trip. This nonlinearity compensator is formed by the multi-pass cell 20 at least one mirror of which is a GTI mirror (preferably at least two mirrors, especially preferred all mirrors except possibly the in- and outcoupling mirror 34 are GTI mirrors). In the illustrated embodiment, all three mirrors 31, 32, 33 are GTI mirrors. If the negative dispersion per bounce on a mirror (meaning the negative dispersion acting on a light pulse each time it hits a surface of a GTI mirror) is −1000 fs², then 20 hits per roundtrip are necessary to achieve the mentioned total negative dispersion. Preferably, even more, such as at least 30 or at least 40 bounces per roundtrip are arranged for.

Separate GTI mirrors 13 of the embodiments of FIGS. 1-4 may also be present but are not necessary and are not shown in FIG. 5.

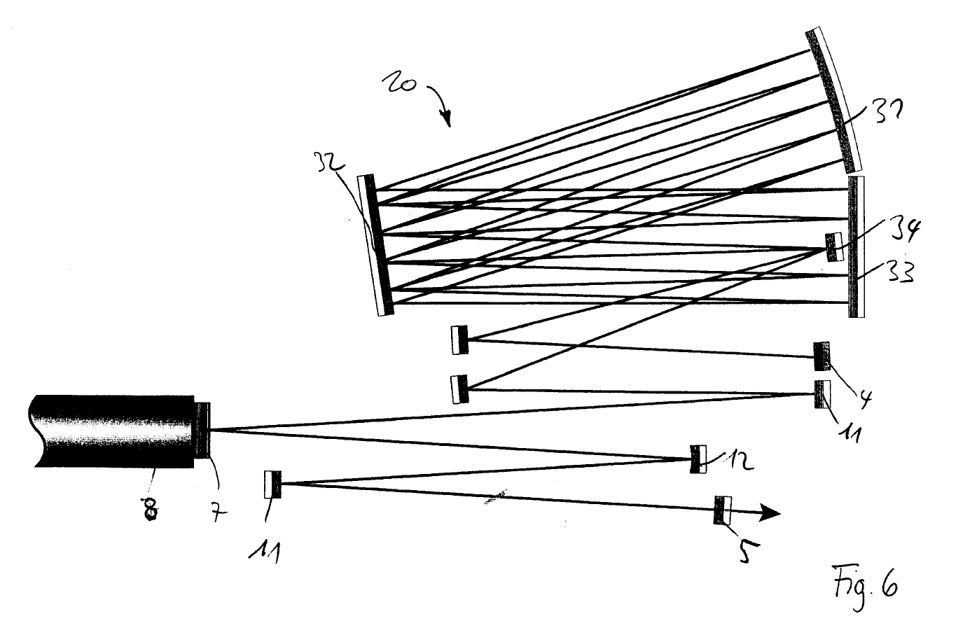

The embodiment of FIG. 6 is distinct from the embodiment of FIG. 5 in that it does not comprise a 4 f extension, and thus, the laser is more compact.

The teachings of FIGS. 1-4 and of FIGS. 5 and 6 may be combined by a laser having the following features:
The nonlinearity of the medium filling the space the pulse travels inside the resonator is reduced by ensuring that the air content of the medium is reduced compared to air of the ambient atmosphere
The remaining nonlinearity is compensated by a nonlinearity compensator of the kind taught with respect to FIGS. 5 and 6.

In all embodiments, the fine tuning of the relationship between dispersion and nonlinearity—and thus by way of equation (1) also of the pulsewidth—may for example take place by the Brewster plate being shiftable along the beam path. Shifting of the Brewster plate changes the nonlinearity originating from the Brewster plate where the beam diameter varies along the beam path (see equation (3)). Thus, a simple means of tuning the pulse width is achieved by this.

Experiments have shown that it is possible to generate sub-picosecond laser pulses of 5 μJ or more, for example with set-ups as illustrated in FIGS. 1 and 3.

In all embodiments, the laser may comprise a plurality of laser heads. This means that the laser may include two or more gain structures, each being, preferably optically, pumped, each on a mount, or (some of) the gain structures being on a common mount. The mount also in this embodiment may be—and preferably is—cooled. In a resonator like any one of the resonators of FIGS. 1-6—or in any other resonator—further laser heads may, for example, be positioned to replace one or more of the flat mirrors 11.

Commercially very attractive applications become possible in this regime, e.g.

Micro-machining
New insight during last years: it is often favorable to work close to the ablation threshold with pulse energies of a few microjoules
For high processing speed (=throughput) at these low pulse energies, high laser repetition rates are required. So far, it was very difficult to operate in this parameter rage (typically amplifier systems were used that operate below 500 kHz).
The invention allows access of the area of 1 MHz to 50 MHz with a very simple and reliable technology (passive mode-locking without the need for amplification stages, pulse pickers, . . . )
Optimal performance for micromachining is achieved with high speed at the ablation threshold. Optimal pulse duration for machining of metals is around 1 ps, i.e. between 500 fs and 5 ps.

Wave-guide writing

Compression system for obtaining sub-100 fs pulses
Fiber compression (see our publication T. Südmeyer, F. Brunner, E. Innerhofer, R. Paschotta, K. Furusawa, J. C. Baggeft, T. M. Monro, D. J. Richardson, U. Keller “Nonlinear femtosecond pulse compression at high average power levels by a large-mode-area holey fiber”, Optics Lett., vol. 28, pp. 1951-1953, 2003)
Filamentation for ultrashort pulses

Wavelength conversion
Diverse nonlinear crystals: Lithium niobate, lithium tantalate, periodically poled lithium niobate or tantalate, stoichiometric lithium tantalate or niobate, lithium borate, cesium lithium borate, beta barium borate, potassium titanyl phosphate, periodically poled potassium titanyl phosphate,
UV generation,
Deep UV and extreme UV generation.

Aspects of UV generation:
Higher wavelength leads to higher precision, e.g. for machining,
Moreover: new applications, e.g. optical inspection systems with extremely high resolution, e.g. for semiconductor inspection systems, e.g. by confocal microscopy.

High harmonic generation (HHG)
HHG is the generation of very short wavelength e.g. in gases, leading to optical power at the 3rd, 5th, 7th, 9th, 11th, 13th, . . . harmonics
Possible applications e.g. in material sciences, semiconductor inspection, . . .
High repetition rate in the MHz range is very attractive because of high signal to noise ratio (often: 1/f noise, so noise in a kHz system is orders of magnitude higher than for our system)

The invention is by no means restricted to the disclosed embodiments but may implemented in many other ways. For example, the pulse repetition rate could be even reduced (and thus the energy per pulse for a given laser power even enhanced by a cavity dumper, which is an optical switch inside the laser resonator to select out an individual pulse. An additional cavity dumper would also allow for the intracavity pulses to be extracted with substantially higher pulse energy inside the resonator—for example with a 5% output coupler, the intracavity pulse energy is approximately 20 times larger than the output pulse energy, and this could be extracted with a cavity dumper being used instead of or in addition to the output coupling mirror. Example: for an output pulse energy of 10 μJ obtained with a 5% output coupler, the intracavity pulse energy is 200 μJ.

As an alternative or in addition to the GTI mirrors, other elements providing negative dispersion such as prisms could be implemented. Instead of saturable absorption, other means of mode locking may be used, such as Kerr lens mode locking or an active mode locking technique.

Alternative embodiments further may include:

Use of a different gas or gas mixture than He with lower nonlinearity than air (e.g. other gas, or other noble gases, such as Ne, etc)

Possibly reduction of the pulse energy circulating in the cavity (by even higher output coupling than 10%, and eg. by increasing the gain with a second laser head).

Additional features that may be implemented in the preferred embodiment include:

Concerning mode-locking process:
optimized resonator atmosphere for stable mode-locking,
variation of the gas pressure in the laser resonator to adjust the laser pulsewidth over a certain range i.e. by adjusting the nonlinearity due to the gas pressure, the laser pulsewidth can be controlled,
suppression of pulse break up,
suppression of QML, for example by ensuring that the relation (Fₗₐₛₑᵣ/F_{sat,laser}) (F_{abs}/F_{sat,abs})>ΔR holds, see U.S. Pat. No. 7,106,764,
suppression of multiple pulsing,

Concerning the thin disk geometry (reference U.S. Pat. No. 5,553,088, which is incorporated herein by reference)
Optimized HR coating, AR coatings,
Optimized pump arrangement and requirements,
Other gain materials (different operating wavelengths, output power levels, and pulsewidths possible).This is especially interesting when going to shorter pulse durations.

The invention may be used in connection with measures concerning spatial hole burning (see U.S. Pat. No. 6,834,064).

Multiple passes (or only a single pass) through the gain material. In the shown embodiments, the pulses go through the gain element twice per roundtrip because the laser head is used as a simple folding mirror. More than two passes, for example four passes, allow for using higher output coupling resulting in lower pulse energy in resonator and reduced nonlinearity.

Design for longer pulse duration resulting in lower peak power and lower nonlinearity in air or gas mixture in the resonator.

Embodiments and Features of Thin-Disk pulsed lasers are also described in U.S. Pat. No. 6,834,064, which is incorporated herein by reference. These embodiments of such lasers, and features of such lasers may be implemented in lasers according to the present invention. Further features of lasers according to the invention are disclosed in U.S. provisional patent application 60/762,671 which is also incorporated herein by reference.

1. A laser for generating pulsed laser radiation, the laser comprising an optical resonator being defined by at least two reflective elements, and the optical resonator defining a laser radiation beam path; the laser further comprising:
a solid-state gain structure arranged so as to be in the beam path, the gain structure being operable to emit laser radiation by stimulated emission upon being pumped;
a housing operable of maintaining a vacuum or a gas composition different from ambient gas within the housing, the housing defining an inside, which encloses at least a part of the optical resonator, so that at least a part of the beam path proceeds within the housing; and
a mode locker arranged so as to be in the beam path;
wherein at least one of the following conditions holds:
the housing is gas-proof and a gas pressure inside the housing is below atmospheric gas pressure;
the housing is gas-proof and a gas atmosphere inside the housing is different from an ambient gas atmosphere;
the housing comprises or is connected to or is connectable connectable to a pump for evacuating gas from the housing;
the housing comprises or is connected to or is connectable to a gas supply for supplying gas of a composition different from an ambient atmosphere to the inside of the housing.

2. The laser according to claim 1, wherein an optical nonlinearity of a gas atmosphere within the housing is lower than an optical nonlinearity of air under atmospheric pressure.

3. The laser according to claim 1, further comprising a cooler being in physical contact with the gain structure.

4. The laser according to claim 1, wherein one of said at least two reflective elements is an outcoupling mirror that is partially transparent for the laser radiation, and wherein the outcoupling mirror comprises a transparency of at least 2%.

5. The laser according to claim 4, wherein the outcoupling mirror comprises a transparency of at least 5%.

6. The laser according to claim 1, comprising at least one element having a negative dispersion for the laser radiation, the element being arranged so as to be in the beam path.

7. The laser according to claim 6, wherein at least one of said elements having a negative dispersion is at least one of said at least two reflective elements.

8. The laser according to claim 1, wherein a gas atmosphere in the housing or suppliable to the housing comprises at least 20% of a noble gas.

9. The laser according to claim 8, wherein said noble gas includes Helium.

10. The laser according to claim 1, wherein said mode locker includes a radiation reflecting element comprising a plurality of semiconductor layers, said reflecting element exhibiting saturable absorption for the laser radiation.

11. The laser according to claim 10, wherein a saturation fluence for said saturable absorption is above 50 μJ/cm².

12. The laser according to claim 11, wherein the saturation fluence is between 50 μj/cm² and 500 μj/cm².

13. The laser according to claim 1, wherein the gain structure includes a disk-like gain element having two end faces, where a first of the end faces is in physical contact with a mount, and where the other one of the end faces is hit by both the laser radiation and the pump radiation, and wherein a structure including the mount and the gain structure then is reflecting for the laser radiation.

14. The laser according to claim 13, wherein the structure including the mount and the gain structure is reflecting for a pump radiation.

15. The laser according to claim 13, wherein the mount includes a cooler.

16. The laser according to claim 1, wherein the laser resonator includes at least one 4 f extension.

17. The laser according to claim 1, wherein the laser resonator includes at least one multi-pass cell.

18. The laser according to claim 1, wherein the laser resonator includes at least one GTI mirror.

19. The laser according to claim 18, comprising a multi-pass cell, wherein at least one of a plurality of mirrors of the multi-pass cell is a GTI mirror.

20. The laser according to claim 1, comprising a Brewster plate shiftable along a beam path for tuning a pulse duration.

21. The laser according to claim 1, comprising a wedged Brewster plate shiftable in a direction that is not parallel to a beam path for tuning a pulse duration.

22. The laser according to claim 1, further comprising at least one further solid-state gain structure arranged so as to be in the beam path, the gain structure being operable to emit laser radiation by stimulated emission upon being pumped.

23. The laser according to claim 1, wherein the solid-state gain structure includes a Yb:YAG gain element.

24. The laser according to claim 1, wherein the solid-state gain structure includes a Yb:KGW or a Yb:KYW gain structure.

25. A laser for generating pulsed laser radiation, the laser comprising an optical resonator being defined by at least two reflective elements, and the optical resonator defining a laser radiation beam path, the laser beam path at least partially traversing a gas atmosphere; the laser further comprising:
a solid-state gain structure arranged so as to be in the beam path, the gain structure being operable to emit laser radiation by stimulated emission upon being pumped;
an optical pump for pumping the gain structure;
a nonlinearity compensator at least partially compensating the calculated and/or measured nonlinearity of the gas atmosphere,
wherein operating parameters of the optical pump, an efficiency of the solid-state gain structure and a beam path length in the resonator are adapted to each other for the laser to yield output radiation pulses of at least 2 μJ radiation energy.

26. The laser according to claim 25, wherein the nonlinearity compensator includes at least one element with a negative dispersion for the laser radiation, wherein the overall negative dispersion acting upon a laser pulse during a roundtrip in the optical resonator is at least 20,000 fs².

27. The laser according to claim 25, wherein the nonlinearity compensator includes at least one GTI mirror and the beam path in the resonator as a whole is such that in each roundtrip in the resonator the beam undergoes at least 20 hits on a GTI mirror surface.

28. The laser according to claim 25, wherein the resonator includes a multi-pass cell.

29. The laser according to claim 28, wherein at least one mirror of the multi-pass cell is a GTI mirror.

30. The laser according to claim 25, further including a passive mode locker.

31. The laser according to claim 25, comprising a housing operable of maintaining a vacuum or a gas composition different from ambient gas within the housing, the housing defining an inside, which encloses at least a part of the optical resonator, so that at least a part of the beam path proceeds within the housing, wherein at least one of the following condition holds:
the housing is gas-proof and a gas pressure inside the housing is below atmospheric gas pressure;
the housing is gas-proof and a gas atmosphere inside the housing is different from an ambient gas atmosphere;
the housing comprises or is connected to or is connectable connectable to a pump for evacuating gas from the housing;
the housing comprises or is connected to or is connectable to a gas supply for supplying gas of a composition different from an ambient atmosphere to the inside of the housing.

32. The laser according to claim 25, wherein the laser radiation beam path is at normal air atmosphere.

33. A laser for generating pulsed laser radiation, the laser comprising an optical resonator being defined by at least two reflective elements, and the optical resonator defining a laser radiation beam path; the laser further comprising:
a solid-state gain structure including an essentially flat gain medium having two end faces, where a first of the end faces is in physical contact with a cooler, and where the beam path hits the other one of the end faces, and where a structure including said gain structure and possibly further including layers in contact with the first end face is reflecting for the laser radiation;
an optical pump operable to impinge the gain structure by pump radiation;
a passive mode locker arranged so as to be in the beam path;
a housing operable of maintaining a vacuum or gas composition different from ambient gas within the housing, the housing defining an inside, which encloses at least a part of the optical resonator, so that at least a part of the beam path proceeds within the housing; and
a means for maintaining a gas atmosphere in the inside of the housing, an air content of which gas atmosphere is lower than an air content of ambient atmosphere;
wherein operating parameters of the optical pump, an efficiency of the solid-state gain structure and a beam path length in the resonator are adapted to each other for the laser to yield radiation pulses of at least 2 μJ radiation energy.

34. The laser of claim 33, wherein a pulse duration of the radiation pulses is 20 ps or smaller.

35. The laser of claim 34, wherein the pulse duration is 2 ps or smaller.

36. A method for generating pulsed electromagnetic laser radiation, the method, comprising the steps of:
exciting an essentially plane thin-disk solid state gain structure, which has a surface extending essentially in a surface plane, to emit laser radiation from said surface, by impinging pump radiation on said solid state gain structure;
recirculating said laser radiation in a beam path in an optical resonator;
mode locking said laser radiation; and
maintaining a gas atmosphere in at least a part of a volume traversed by the beam path, which gas atmosphere has an air content of which gas atmosphere is lower than an air content of ambient atmosphere.
